(19) United States
(12) Patent Application Publication
(10) Pub. No.: US 2015/0348052 A1
(43) Pub. Date: Dec. 3, 2015

(54) CRM-BASED DISCOVERY OF CONTACTS AND ACCOUNTS

(71) Applicants: Sachin Rekhi, Mountain View, CA (US); Gayathiri Ramadevi Lakshmanan, Santa Clara, CA (US); Qi Liu, Saratoga, CA (US); Annabel Fang Liu, Los Altos, CA (US)

(72) Inventors: Sachin Rekhi, Mountain View, CA (US); Gayathiri Ramadevi Lakshmanan, Santa Clara, CA (US); Qi Liu, Saratoga, CA (US); Annabel Fang Liu, Los Altos, CA (US)

(21) Appl. No.: 14/473,694

(22) Filed: Aug. 29, 2014

Related U.S. Application Data
(60) Provisional application No. 62/005,523, filed on May 30, 2014.

(51) Int. Cl. G06Q 30/00

(52) U.S. Cl. CPC G06Q 30/016

(57) ABSTRACT

In an example embodiment, a request to onboard a first user to a software tool is received. A first query is performed on information in a Customer Relationship Management (CRM) system to obtain a first set of CRM entities of a first type. Then a second query is performed on information in the CRM system to obtain a second set of CRM entities of the first type, the first and second queries designed to retrieve CRM entities related to the first user. Results of the first and second queries are stored in the software tool as a single data type, wherein the software tool is separate and distinct from the CRM system and is configured to provide insights into the results based at least in part on information from social network profiles related to the results.

### RELATED APPLICATIONS

This application claims priority to U.S. Provisional Application No. 62/005,523, entitled “CRM-BASED DISCOVERY OF CONTACTS AND ACCOUNTS”, filed May 30, 2014, which is incorporated by reference herein in its entirety.

### TECHNICAL FIELD

This application relates to the technical fields of computer software and, in one example embodiment, to discovery of contacts and accounts based on customer relationship management (CRM)

### BACKGROUND

CRM is a system used to manage an entity's interactions with current and future customers. It often involves utilizing technology to organize, automate, and synchronize sales, marketing, customer service, and/or technical support. The general goal of CRM systems is to enable entities to better manage their customers through the introduction of reliable systems, processes, and procedures for interacting with those customers. CRM systems are also used to manage business contacts, clients, contract wins, sales leads, etc.

From the salesperson perspective, there are number of different tools providing sales intelligence that are available to salespeople. These salespeople, however, continue to rely upon CRM systems almost exclusively and thus these other tools that are not able to leverage CRM information because of the low adoption rate of salespeople.

### BRIEF DESCRIPTION OF DRAWINGS

Embodiments are illustrated by way of example and not limitation in the figures of the accompanying drawings, in which like reference numbers indicate similar elements and in which:

FIG. 1 is a block diagram illustrating a system for CRM-based discovery of accounts and contacts.

FIG. 2 is a block diagram illustrating a synchronization module in accordance with an example embodiment.

FIG. 3 is a diagram illustrating an example of CRM rules in accordance with an example embodiment.

FIG. 4 is a flow diagram illustrating a method for retrieving CRM entities from a CRM system for onboarding of a user into a tool in accordance with an example embodiment.

FIG. 5 is a flow diagram illustrating a method for executing a rule set by an identified CRM interface to retrieve CRM entities from the CRM system in accordance with an example embodiment.

FIG. 6 is a block diagram illustrating a synchronization module in accordance with an example embodiment.

FIG. 7 is a flow diagram illustrating a method for mapping an account from a CRM system to a company/organization in profiles and profile-related information in a social networking service, in accordance with an example embodiment.

FIG. 8 is a flow diagram illustrating a method for performing a similarity matching process on one or more fields on an account from a CRM system and corresponding fields in social network profiles and profile-related information.

FIG. 9 is a block diagram illustrating a synchronization module in accordance with an example embodiment.

FIG. 10 is a flow diagram illustrating a method for mapping a contact from a CRM system to a profile in a social networking service, in accordance with an example embodiment.

FIG. 11 is a flow diagram illustrating a method for performing a similarity matching process on one or more fields of a contact from a CRM system and corresponding fields in social network profiles, in accordance with an example embodiment.

FIG. 12 is a block diagram illustrating a mobile device according to an example embodiment.

FIG. 13 is a block diagram of machine in the example form of a computer system within which instructions, for causing the machine to perform any one or more of the methodologies discussed herein, can be executed.

### DETAILED DESCRIPTION

### Overview

The present disclosure describes, among other things, methods, systems, and computer program products, which individually provide functionality for a sales tool. In the following description, for purposes of explanation, numerous specific details are set forth in order to provide a thorough understanding of the various aspects of different embodiments of the present inventive subject matter. It will be evident, however, to one skilled in the art, that the present inventive subject matter may be practiced without all of the specific details.

In an example embodiment, a sales tool is provided that provides an account-centric view optimized for ideal sales workflows. Prospecting for new leads and accounts is simplified based on look-alike modelling, and sales professionals can be proactively notified of actionable insights on target accounts and leads.

In an example embodiment, the sales tool (and/or other sales tools) may be augmented by providing a mechanism to automatically import data from a CRM system and use this data for sales analysis and recommendations. For example, information about accounts and contacts for a salesperson can be automatically imported from the CRM system and applied in the sales tool to provide for recommendations of potential leads for new sales.

As used herein, the term “or” may be construed in either an inclusive or exclusive sense. Similarly, the term “exemplary” merely means an example of something or an exemplar and not necessarily a preferred or ideal means of accomplishing a goal. For the purposes of this description, the phrase “an on-line social networking application” may be referred to as and used interchangeably with the phrase “an on-line social network” or merely “a social network.” It will also be noted that an on-line social network may be any type of an on-line social network such as, for example, a professional network, an interest-based network, or any on-line networking system that permits users to join as registered members. For the purposes of this description, registered members of an on-line social network may be referred to as simply members.

It should be noted that the terms “contacts” and “leads” both are intended to refer to individuals. In the CRM environment it is typical to refer to such individuals as contacts and the information pertaining to those individuals stored in the CRM system as contact information. In the sales tool as described in this disclosure, it is common to refer to such individuals as leads, and the information pertaining to those individuals stored in the sales tool as lead information. Thus, in order to maintain this nomenclature, the present disclosure will refer to individuals as contacts with respect to the CRM systems and leads with respect to the sale tool (or any other tool or non-CRM environment, such as in the social network service). For example, if information about an individual is imported from a CRM system to the sales tool, then the present disclosure may refer to it as importing a contact from the CRM system and saving it as a lead in the sales tool. Nevertheless, this is merely a nomenclature to remain consistent with usage in the field, and such terms shall be construed as interchangeable.

The process of importing accounts and contacts from a CRM system to the sales tool or other tool and getting a user set up in that tool is known as “onboarding”. In an example embodiment, this onboarding may be performed in a tool that is integrated with an on-line social network to further leverage information across domains. Each member of an on-line social network is represented by a member profile (also referred to as a profile of a member or simply a profile). A member profile may be associated with social links that indicate that member's connection to other members of the social network. A member profile may also include or be associated with comments or endorsements from other members of the on-line social network, with links to other network resources such as, for example, publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Reputation scores may be computed based on information obtained from trusted sources, such as patent databases, publications databases, skills, endorsement of skills, or even enterprise contracts.

In addition to member profiles, there may be a number of different types of data stored by the social network site. Additionally, data from other data sources, such as audio and video content, email and business documents, calendars, text messages, etc. may also be accessed by the social network site. It would be helpful if all this data can be accessed in an efficient manner and that whatever features the social network site is attempting to set up to access new data types or new data sources can be set up in an efficient manner.

Notably the members of the social network need not be individuals but can be businesses as well. For example, a company itself may be a member of the social network site and have a company profile page in the social network site, while employees of the company may each individually be members and have their own member pages, perhaps linked to the company profile page.

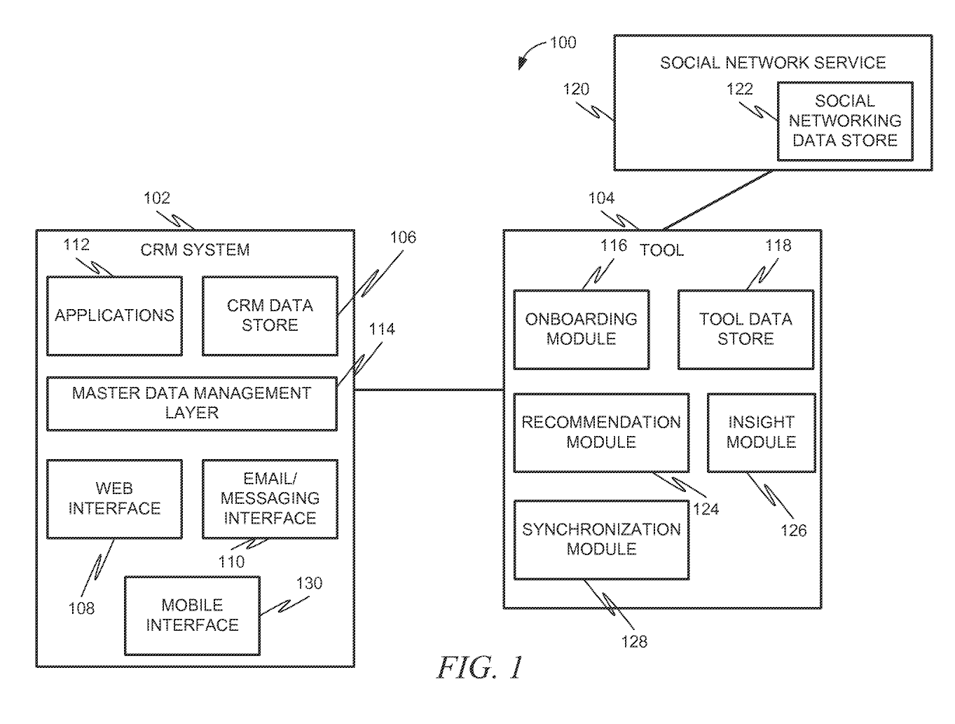

FIG. 1 is a block diagram illustrating a system 100 for CRM-based discovery of accounts and contacts. The system 100 may include a CRM system 102 and a tool 104. The tool 104 may be, for example, a sales tool that provides various sales insights. The CRM system 102 may include a CRM data store 106 that stores information about accounts and contacts for various users. In an example embodiment, the CRM system 102 may be offered as a Software as a Service (SaaS) component and thus the system 100 may be stored on a server or distributed among multiple servers. However, in some example embodiments the CRM system 102 and/or the CRM data store 106 may be located on a non-server computer such as a desktop computer, laptop computer, or mobile device. The CRM system 102 may include a web interface 108 to allow users to interact with the CRM system 102 via a web browser. The CRM system 102 may also include an email/messaging interface 110 that may interface with various other programs such as email or messaging clients to exchange information related to CRM tasks. The CRM system 102 can also include one or more marketing applications 112. A master data management layer 114 can be used to manage in all of the components in the CRM system 102.

The tool 104 may include an onboarding module 116 that is used to set up new users. As with the CRM system 102, the tool 104 may be implemented as a SaaS component on a server or distributed among multiple servers, although embodiments are possible where the tool 104 is located on a non-server computer. The data can be stored in tool data store 118.

Also contained in the system 100 is a social network service 120. The social network service 120 may contain various social networking profiles and links between the profiles, stored in a social networking data store 122. As with the CRM system 102, the social network service 120 may be implemented as a SaaS component on a server or distributed among multiple servers.

In an example embodiment, a recommendation module 124 can also be provided in the tool 104. The recommendation module 124 can recommend further accounts and/or leads from the social network service 120 based on a variety of factors.

In an example embodiment, an insight module 126 can also be provided in the tool 104. The insight module 126 can act to provide insights about the accounts and/or leads associated with a user. This may include mining data in the social network service 120 as well as information from the Internet in general (e.g., news searches, web page searches, etc.) to provide information about the accounts and/or leads that might be valuable to the user. For example, the user may be presented with recent news articles about an account, or a personal web page of a lead. This can enable the user to have, for example, information useful in breaking the ice or otherwise conversing with the account and/or lead, whether remotely (e.g., by email or phone) or in person (e.g., at a party).

In an example embodiment, a synchronization module 128 can also be provided in the tool 104. The synchronization module 128 can synchronize data between the tool data store 118 and the CRM data store 106, and can also be used to integrate the CRM information into the tool 104. The synchronization module 128 can utilize the profile and link information stored in the social networking data store 122 to aid in the onboarding process. This will be described in more detail below.

There may, of course, be other modules contained within the tool 104 that are not described here to provide additional functionality to the user.

Additionally, in some example embodiments the CRM system 102 may also contain a mobile interface 130, used to interface with one or more mobile devices.

In an example embodiment, accounts and/or contacts are retrieved from a CRM system. Accounts include account-level information about entities such as companies or other organizations. Contacts include contact-level information about individuals. The system can then attempt to map each account to a social network profile for a company or organization and map each contact to a social network profile for an individual. The system is then able to generate within the tool insights based on this information.

Most CRM systems have both accounts and contacts. Accounts and contacts may generally be referred to as CRM entities.

### CRM-Based Discovery of Accounts and Contacts

One issue that arises in onboarding users to the tool 104 when those users had previously used a CRM system 102 is that people use CRM systems in a number of different ways, and thus CRM entities are not stored in a uniform fashion that can be easily queried or mapped. This comes from not only the plethora of CRM systems available but also the customizability of the CRM systems, with individual companies or even users creating a customized version of the CRM system. This adds significant complexity to the mapping process.

For example, a particular implementation of a CRM system may allow accounts assigned to a user to be labeled with an owner identifier indicating that the particular user “owns” the account. However, that CRM system may alternatively provide for the concept of account team members, with groupings of team members associated with accounts. This information, of course, is then potentially saved in different fields in the data for a user. Thus, a query for all accounts assigned to a user is not as simple as just looking for accounts having a user ID in an owner field; for example, a query may also need to look for all accounts for which the user is an account team member. In an example embodiment, the system is intelligent enough to handle many different use cases of customized CRM systems.

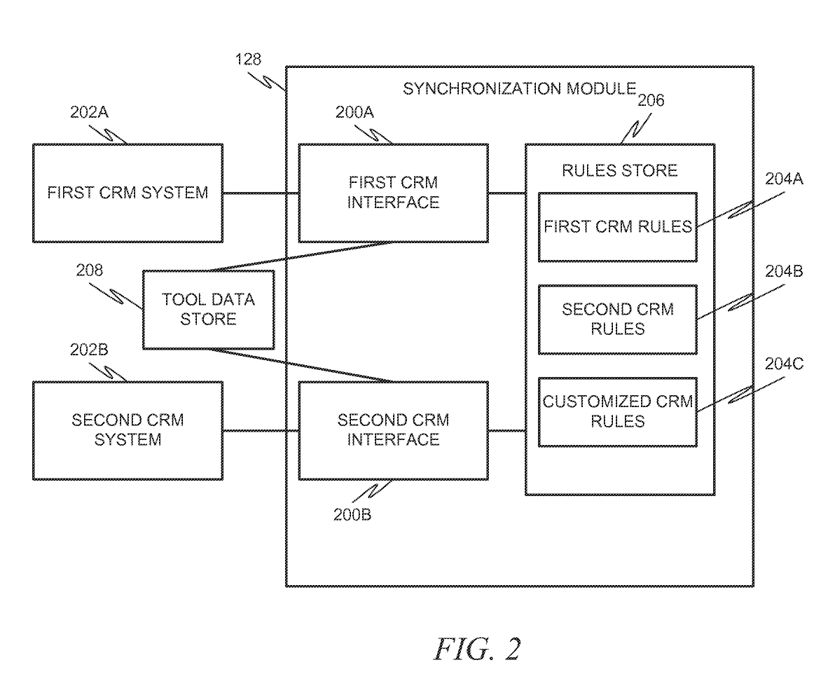

FIG. 2 is a block diagram illustrating a synchronization module, such as the synchronization module 128 of FIG. 1, in accordance with an example embodiment. The synchronization module 128 may include a first CRM interface 200A coupled to a first CRM system 202A. This first CRM system 202A may be, for example, the CRM system 102 of FIG. 1. The first CRM interface 200A may access first CRM rules 204A stored in a rules store 206. The rules store 206 may, for example, be part of tool data store 118 of FIG. 1, although in some example embodiments the rules store 206 may be a separate component. The first CRM rules 204A define a set of rules that are used to retrieve accounts and/or contacts from the first CRM system 202A.

In a further example embodiment, different rules can be established for different CRM systems. These different CRM systems can be different instances of the same CRM architecture (perhaps customized differently, although perhaps alternatively merely containing different data). In another example embodiment, the different CRM systems can be completely different CRM system architectures (e.g., CRM systems offered by different manufacturers). As such, different interfaces may be provided for each different CRM system. The second CRM interface 200B may be used to retrieve accounts and/or contacts from the second CRM system 202B, utilizing second CRM rules 204B stored in the rule store 206.

While not pictured, there may be any number of different CRM interfaces and CRM rules provided to allow for retrieval of accounts and/or contacts from many different CRM systems. Each CRM interface may implement the corresponding rules retrieved from the rules store 206 along with procedures and functions tailored for retrieval of information from the particular corresponding CRM system. Thus, while the CRM rules may define a process of steps and ordering of steps to be performed when retrieving accounts and/or contacts from the CRM system, the CRM interface may further include its own procedures on how data is actually retrieved from the CRM system. This may include storing and using information such as CRM System database addresses, query protocols, data type protocols, and general communications protocols. It should be noted that there may be overlap between what procedures could be defined in the CRM rules and what procedures could be defined in the corresponding CRM interfaces such that certain functionality may be contained in either a CRM rule or a CRM interface based on designer preference.

In an example embodiment, a company or user can specifically customize the CRM query or queries to further aid in the mapping. This may be performed by creating customized CRM rules 204C in the rules store 206, which then can be used by a specified CRM interface when that specified user (or users working for the specified company) are onboarded. Thus, for example, company XYZ can create customized CRM rules 204C to be used by the first CRM interface 200A when an employee of company XYZ is onboarded, causing the first CRM interface 200A to utilize different procedures to retrieve accounts and/or contacts from the first CRM system 202A than it would use if a user who wasn't an employee of company XYZ was onboarded and wanted to retrieve accounts and/or contacts from the first CRM system 202A (presumably in the latter case the first CRM interface 200A would utilize the first CRM rules 204A, or a different set of customized CRM rules (not pictured)).

For contacts, CRM systems may link contacts to accounts records and/or opportunity records. Account records correspond to companies while contact records correspond to individuals. In an example embodiment, there is a direct connection between account records and contact records, thus when an account is imported from the CRM, corresponding contact records could also be imported. However, this may result in too many contacts being imported, because it is quite possible that only a subset of employees, for example, working at an account are relevant contacts for a particular salesperson. In order to prevent this, in an example embodiment the system may examine the owner identifier of individual contacts in the CRM system to see which contacts are appropriate for a given user.

Additionally, salespeople also may create opportunity records in the CRM system. An opportunity record describes an opportunity for the salesperson to potentially gain an account, and will often list one or more contacts for that particular opportunity. Thus, a contact may be linked to a particular opportunity that is associated with a user despite the fact that the contact itself is not “owned” or otherwise associated with the user. In an example embodiment, contacts are pulled from the opportunity records and mapped to objects in the social networking site in order to create contact records for the user.

In another example embodiment, alternative signals may be used as well. Contact records typically have notes and activity records associated with them. In some cases a salesperson may not have explicitly entered a contact or linked to a contact in the CRM system, but may have entered notes and/or activity records describing the contact. This information could also be retrieved and utilized in the mapping.

All of the CRM entities extracted from the CRM systems may be stored in the tool data store 208, which may then be used for mapping as will be described in more detail later.

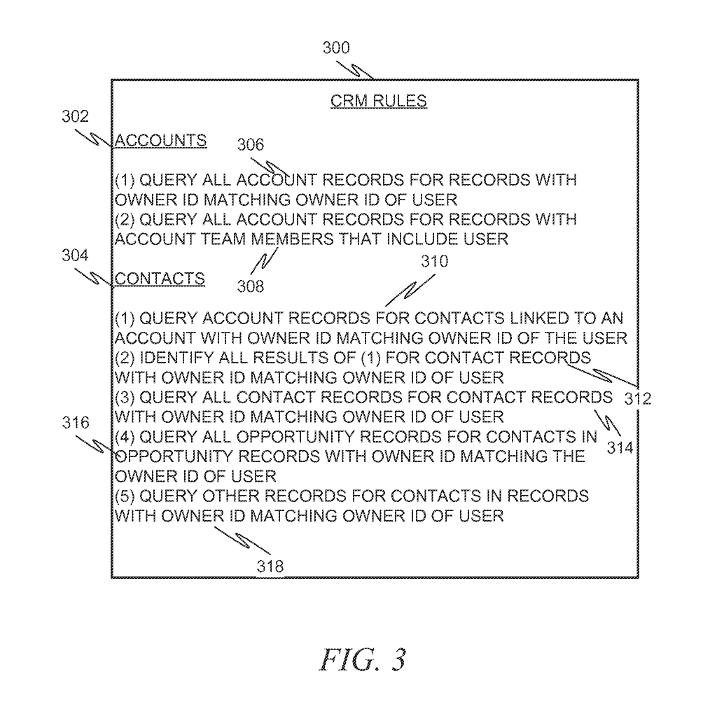

FIG. 3 is a diagram illustrating an example of CRM rules in accordance with an example embodiment. This diagram represents a simplified example of CRM rules and is presented in normal conversational English as opposed to a strict rules based language in which the rules may be actually implemented. The rule set 300 is divided into two portions: rules related to accounts 302 and rules related to contacts 304. Beginning with rules related to accounts 302, a first rule 306 may indicate that the CRM interface should perform a query for all account records that have an owner ID matching an owner ID of the user being onboarded. A second rule 308 may indicate that the CRM interface should perform a query for all account records that have account team members that include the user being onboarded.

Turning now to rules related to contacts 304, a first rule 310 may indicate that the CRM interface should perform a query for all contacts linked to an account (e.g., listed in account records) having an owner ID matching an owner ID of the user being onboarded. Thus, for example, if company XYZ is an account owned by the user, then all contacts linked to company XYZ can be retrieved. A second rule 312 may indicate that the CRM interface should identify, in the set of retrieved contacts from the first rule, a subset of contacts that have an owner ID matching an owner ID of the user being onboarded. A third rule 314 may indicate that the CRM interface should retrieve other contacts that have an owner ID matching the owner ID of the user being onboarded. This may result in searching through contact records (rather than account records) for contacts who may be “owned” by the user but are not associated with an account “owned” by the user. This could help to retrieve, for example, a contact who is not employed, is self-employed, or is erroneously not linked with an account (e.g., misspelling in the company name in the contact record).

A fourth rule 316 may indicate that the CRM interface should retrieve contacts listed in opportunity records that have an owner ID matching the owner ID of the user being onboarded.

A fifth rule 318 may indicate that the CRM interface should retrieve contacts listed in any other records in the CRM system that have an owner ID matching the owner ID of the user being onboarded.

At this point, the system may have retrieved a list of accounts and contacts. It can then proceed to pull as much information from the CRM system about those accounts and contacts as it can. This can include pulling basic fields such as name, identifier, uniform resource locator (URL), industry, shipping address, billing address, and last record modification date for accounts. This can also include pulling basic fields such as name, email address, title, company, address, and phone number for contacts.

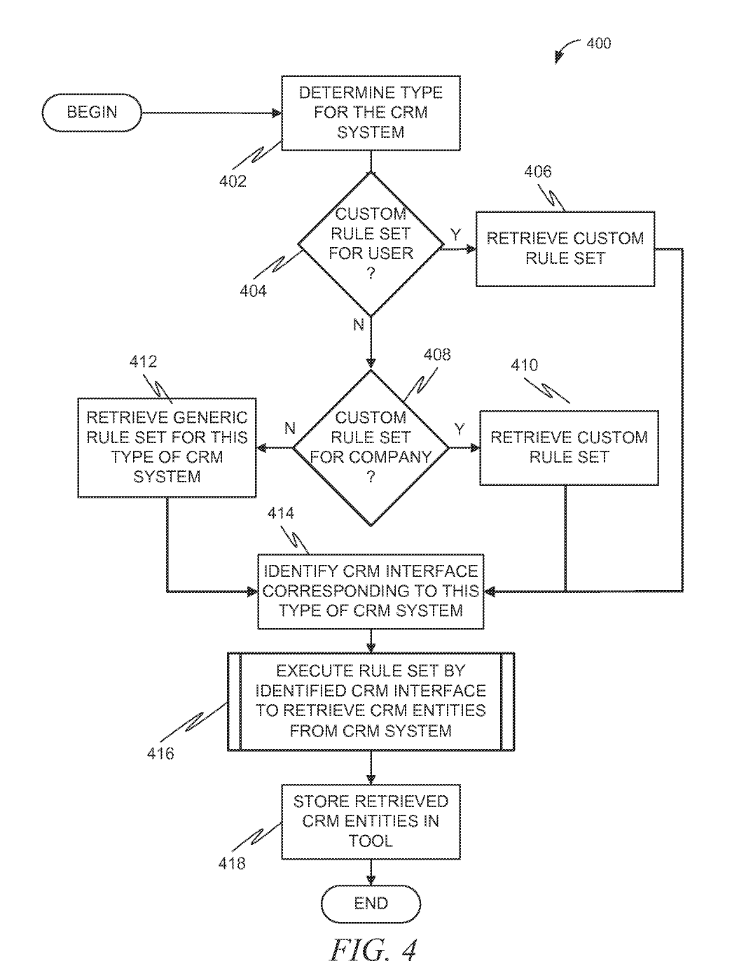

FIG. 4 is a flow diagram illustrating a method 400 for retrieving CRM entities from a CRM system for onboarding of a user into a tool in accordance with an example embodiment. At operation 402, a type is determined for the CRM system. At operation 404, it is determined if there is a custom rule set for the user for the type of the CRM system. If so, then the custom rule set is retrieved at operation 406. If not, then at operation 408 it is determined if there is a custom rule set for a company that the user is associated with for the type of the CRM system. If so, then the custom rule set is retrieved at operation 410. If not, then at operation 412 a generic rule set for the type of CRM system is retrieved.

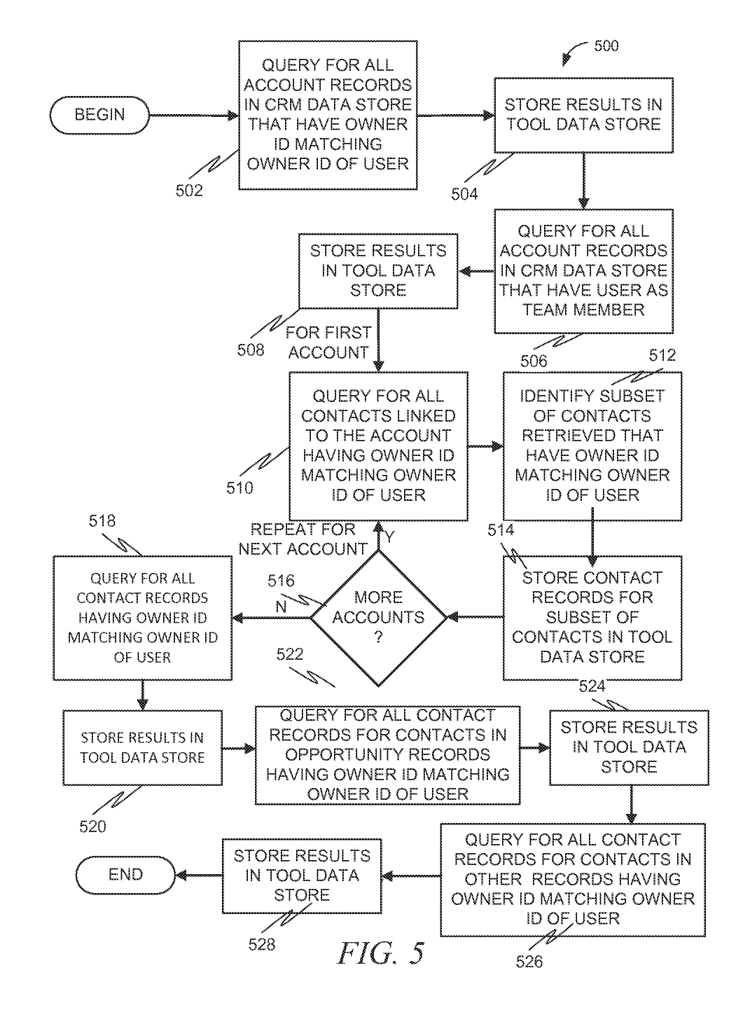

At operation 414, a CRM interface corresponding to the type of CRM system is identified. At operation 416, the rule set is executed by the identified CRM interface to retrieve CRM entities from the CRM system. This may be performed in a number of different ways based on the rule set and based on the CRM interface. One such way is described with respect to FIG. 5 below. At operation 418, the retrieved CRM entities are stored in the tool.

FIG. 5 is a flow diagram illustrating a method 500 for executing a rule set by an identified CRM interface to retrieve CRM entities from the CRM system in accordance with an example embodiment. This method 500 may represent operation 416 of FIG. 4 in more detail. At operation 502, a query for all account records in the CRM data store that have an owner ID matching an owner ID of the user is performed. At operation 504, the results of operation 502 are stored in a tool data store. At operation 506, a query for all account records that have account team members that include the user is performed. At operation 508, the results of operation 506 are store in the tool data store. An iterative approach can then be taken for each account record retrieved by either operation 502 or operation 506. Specifically, at operation 510, a query for all contacts linked to the account having an owner ID matching an owner ID of the user is performed. Then, at operation 512, a subset of the contacts retrieved at operation 510 that have an owner ID matching an owner ID of the user are identified. At operation 514, the contact records for the subset of contacts identified in operation 512 are stored in the tool data store. At operation 516, it may be determined if there are any more account records retrieved by either operation 502 or operation 506 to examine. If so, then the process may loop to operation 510 with the next account record. If not, then the process may proceed to operation 518.

At operation 518, a query for all contact records having an owner ID matching the owner ID of the user, but that are not associated with an account having an owner ID matching the owner ID of the user is performed. At operation 520, the results of operation 518 are stored in the tool data store. At operation 522, a query for all contact records of contacts listed in opportunity records that have an owner ID matching the owner ID of the user is performed. At operation 524, the results of operation 522 are stored in the tool data store. At operation 526, a query for any other records in the CRM system that have an owner ID matching the owner ID of the user being onboarded is performed. At operation 528, the results of operation 526 are stored in the tool data store.

### CRM Account to Company Mapping

At this point, the tool has the CRM entities, including accounts and/or contacts from the CRM system(s), stored in the tool data store. The next issue is how to map these accounts and/or contacts to entities that can be easily used by the tool. In an example embodiment, this means identifying a company, or set of companies, for each CRM account listed in social network profiles, as well as identifying a social network profile for the individuals (leads) corresponding to each CRM contact. This section of the disclosure will describe the CRM account-to-company mapping, whereas CRM contact to social network profile mapping will be described later.

In an example embodiment, every company/organization in the social network service (i.e., listed as a company/organization in some social network profile) has a unique identifier and a list of canonical names associated with the identifier. The canonical names may reflect, for example, the different names the users have entered for the company/organization. This may include, for example, the official name of the company, subsidiaries of the company, and also alternative (even incorrect) spellings for the company. In an example embodiment, the tool takes these canonical names stored in a social network data store and divides them into unordered, skip n-grams. For example, if one of the names associated with the company is Widget Machine Products, Inc., then skip 2-grams may include “Widget Machine,” “Widget Products,” “Widget Inc.,” “Machine Products,” “Machine Inc.,” etc. These may be saved as vectors. A similarity match may then be performed between the CRM accounts now stored in the tool data store and the canonical names from the profiles and profile-related information stored in the social network data store. Profile-related information is information stored in a social network service related to the profiles but not necessarily stored in the profiles themselves. This may include, in some social network services, link information between profiles.

Fields other than name can be used to locate matching companies/organizations. For example, email address can be used as another field potentially locating matches. Thus, for example, even if no matches are found by comparing names (i.e., there is no profile or profile-related information matching the company name imported from the CRM system), then a matching organization may still be found by examining email addresses.

In an example embodiment, for each of the fields, the similarity match performed is a cosine similarity match. This allows the results to indicate a “1” if there is a complete match and a “0” if there is no match at all. A threshold may be set somewhere between 0 and 1 to allow the system to accept matches above that threshold and disallow matches below that threshold. A set of the highest rated matches could then be returned. The set size is customizable and may be between 1 and any other positive integer.

In an example embodiment, a minimum number of matches is set such that if the set returned via the cosine similarity on n-grams for company/organization names has a size less than the minimum, additional matches may be retrieved by performing a cosine similarity match using a different field, such as address, email address, domain name, etc. Indeed, a progression of different fields may be specified so that the system may step through each one and perform the matching algorithm until the overall number of returned matches meets or exceeds the minimum. The results from a similar match from each of these fields may be considered a separate “signal.”

In another example embodiment, this process may occur in parallel, such that a matching algorithm is performed for each field in parallel. The signals may then be weighted and a total score derived to determine whether a “match” has been found.

Additionally, in another example embodiment, a learning algorithm can be used to improve a low strength signal based on a threshold number of profiles in the social network data store identifying the value for the low-strength signal. For example, an email domain that has been used by a large number of individuals associated with a particular company's profile may be “learned” as an associated email domain despite not having a common name with the company name. For example, Widget Machine Products, Inc. may have a charitable arm known as “dogood.org.” If enough user profiles associated with Widget Machine Products, Inc. in the social network site list the dogood.org domain as an email domain, the system may assume that dogood.org should be associated with Widget Machine Products. Inc.

Additionally, in an example embodiment, a first pass ranking algorithm may be used to speed up the matching process. In the first pass ranking algorithm, likely candidates from the social network site are retrieved in a first pass without performing the complete cosine similarity match process. The second pass (or, in some embodiments, later passes, as there is no requirement that the algorithm only use two passes) performs the complete cosine similarity match process. This is useful in systems where the number of profiles in the social network site is quite large, making it difficult to perform a complete cosine similarity match on all profiles in an efficient manner.

There is also the possibility that no matches will be found. In an example embodiment, in the case where no match is found, a ghost account can be created. This allows the system to still be able to add leads to an account even if specific information, such as a company name, is not known about the account. This would be the case if, for example, contacts map correctly but companies do not. In such a case, it would still be possible for the tool to be used to provide insights in such cases.

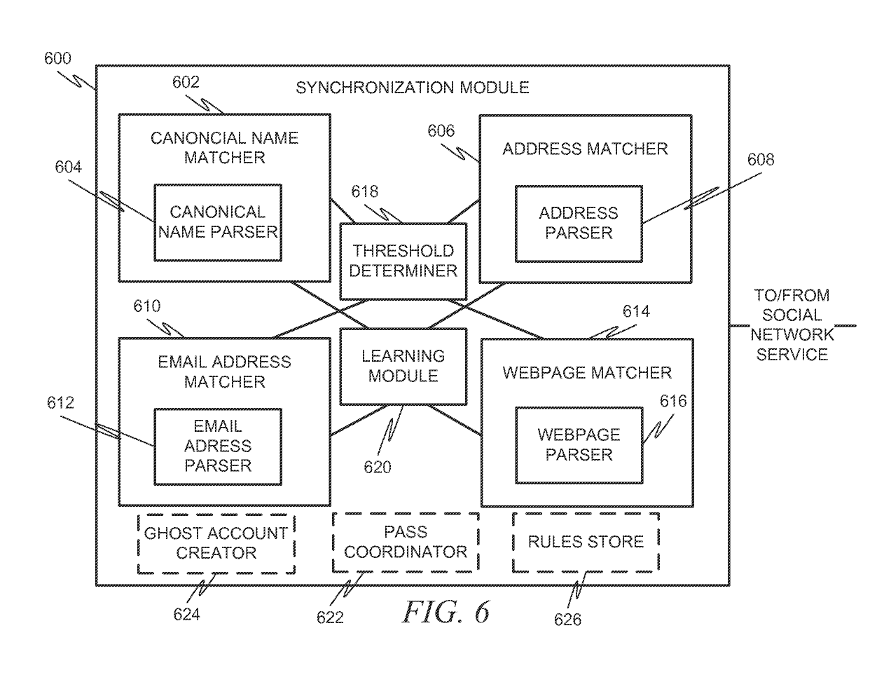

FIG. 6 is a block diagram illustrating a synchronization module 600, such as the synchronization module 128 of FIG. 1, in accordance with an example embodiment. The synchronization module 600 depicted here shows elements used to execute tasks related to mapping accounts stored in the tool data store 208. In one embodiment, the elements in FIG. 6 and the elements in FIG. 2 are all combined into one synchronization module. However, embodiments are possible where the implementation of FIG. 6 utilizes data stored in the tool data store 208 that was acquired using different elements than those depicted in FIG. 2; hence they are depicted in separate diagrams.

The synchronization module 600 is shown as interfacing with a social network service to retrieve profiles and profile-related information. These profiles and profile-related information are used to map accounts from the CRM systems to companies/organizations in the social network service. Notably, in some example embodiments the synchronization module 600 may not directly interface with the social network service. Rather, another module may retrieve the needed information and store it in a memory, perhaps in the tool data store 208.

A canonical name matcher 602 may act to attempt to match name information from accounts (stored as account information in the tool data store 208) with company/organization names from the profiles and profile-related information. The canonical name matcher 602 may include a canonical name parser 604 used to parse canonical names into skip n-grams of either words or characters. Specifically, in one example embodiment, the canonical name parser 604 parses canonical names from both the CRM account information from the CRM system and the company/organization names from the profile and profile-related information into skip 2-grams of either words or characters.

An address matcher 606 may act to attempt to match address information from accounts with addresses from the profiles and profile-related information. This may utilize an address parser 608 to parse the addresses into skip n-grams of either words or characters.

An email address matcher 610 may act to attempt to match email address information from accounts with addresses from the profiles and profile-related information. This may utilize an email address parser 612 to parse the email addresses into skip n-grams of either words or characters.

A webpage matcher 614 may act to attempt to match webpage information from accounts with webpages from the profiles and profile-related information. This may utilize a webpage parser 616 to parse the webpages into character skip n-grams of either words or characters. It should be noted that the term “webpages” as used in this context may refer to a webpage address such as a Uniform Resource Locator (URL) corresponding to a document, such as an HyperText Markup Language (HTML) file, representing a web page.

A threshold determiner 618 may act to determine if a potential match meets or exceeds a threshold matching value. As described above, a cosine similarity match may be performed for each field, and thus the threshold determiner 618 may determine whether the calculated cosine similarity value meets or exceeds a predefine threshold. If so, then a match has been found. It should be noted that the threshold determiner 618 can be utilized on a field-by-field basis or on all fields as a whole. For example, there may be a first threshold for matches by canonical name, a second threshold for matches by address, a third threshold for matches by e-mail address, and a fourth threshold for matches by webpage. Alternatively, there may be one threshold for a weighted average of cosine matching values of the fields.

A learning module 620 may act to improve a low strength signal based on a threshold number of profiles in the social network data store identifying the value for the low-strength signal. Thus, the learning module 620 can interact with the canonical name matcher 602, address matcher 606, email address matcher 610, and/or webpage matcher 614 to alter the effect of the similarity match of each. Alternatively, the learning module 620 can dynamically alter the weight assigned to each field by the threshold determiner 618.

A pass coordinator 622 may act to implement a first pass ranking algorithm that may be used to speed up the matching process. This first pass ranking algorithm can operate the various similarity match algorithms for each of the fields in any order, which can act to reduce the processing cycles needed to locate matches.

A ghost account creator 624 may act to create a ghost account for a company/organization name in an account if no match is found in the company/organization names in the profiles and profile-related information.

It should be noted that much like with the import of the CRM entities from the CRM systems, the actions taken by the synchronization module 600 with respect to mapping accounts to company/organization names in the profiles and profile-related information can be customized in a number of ways. There may be customized rules for implementing these actions based, for example, on the user being onboarded, the company the user being onboarded works at, or the type of the CRM system from which the account information was imported. These custom rules may be stored in a rules store 626 and accessed as needed by the other components of the synchronization module 600.

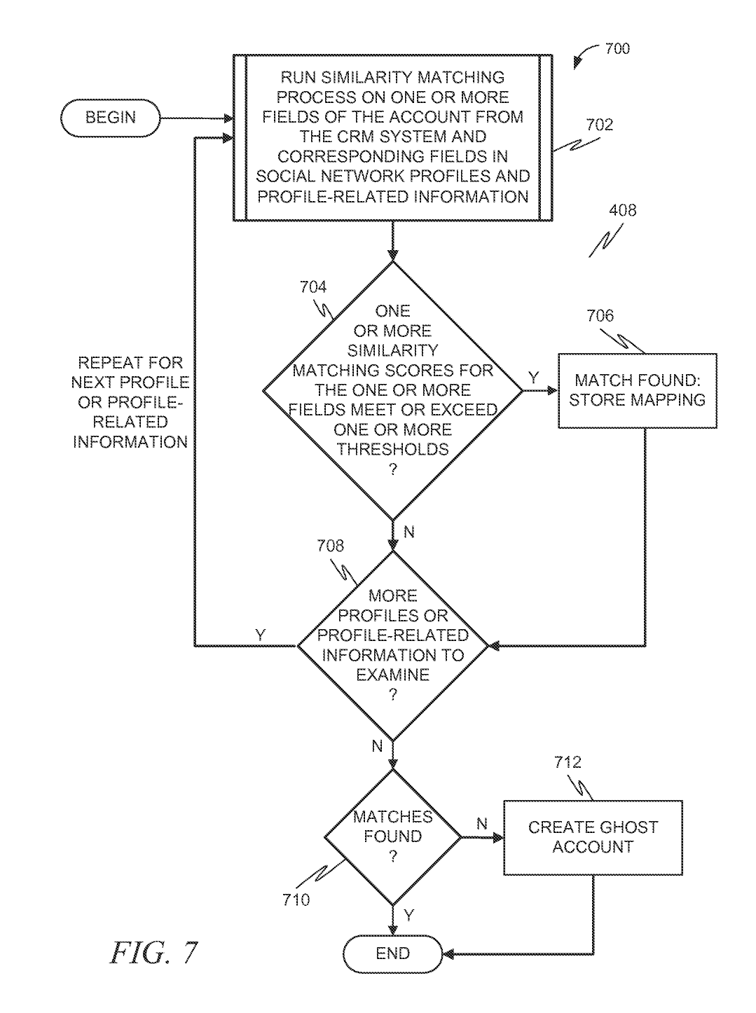

FIG. 7 is a flow diagram illustrating a method 700 for mapping an account from a CRM system to a company/organization in profiles and profile-related information in a social networking service, in accordance with an example embodiment. At operation 702, a similarity matching process is run on one or more fields of the account from the CRM system and corresponding fields in social network profiles and profile-related information. At operation 704 one or more similarity matching scores for the one or more fields are compared with one or more thresholds. If the similarity matching scores meet or exceed the thresholds, then at operation 706 a match has been found and a mapping between the CRM account record and the corresponding social network profiles and profile-related information is stored. If not, then no match is found and at operation 708 it is determined if there are any more profiles or profile-related information to examine. If so, then the process loops to operation 702 for the next profile or profile-related information. This looping also occurs if there was a match. Once all the profiles and profile-related information has been examined, then at operation 710 it is determined if any matches were found. If not, then at operation 712 a ghost account is created for the account and a mapping between the account and the ghost account is stored. If so, then the method 700 ends.

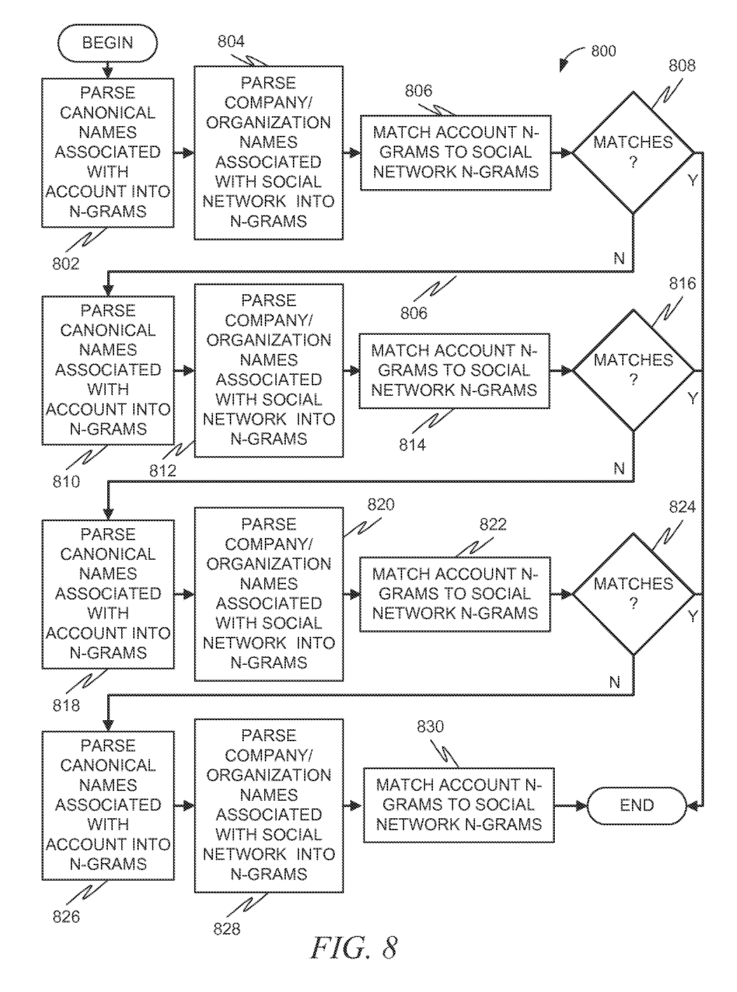

FIG. 8 is a flow diagram illustrating a method 800 for performing a similarity matching process on one or more fields on an account from a CRM system and corresponding fields in social network profiles and profile-related information. In an example embodiment, this method 800 may represent operation 702 of FIG. 7 in more detail.

At operation 802, canonical names associated with the account are parsed into skip n-grams. At operation 804, company/organization names associated with social network profiles and profile-related information are parsed into skip n-grams. It should be noted that while in this diagram operation 804 is depicted as being performed after the canonical names associated with a particular account are parsed, in some embodiments the names associated with social network profiles and profile-related information may be parsed beforehand, perhaps in a batch process occurring periodically regardless of when or if matching may need to occur. At operation 806 the skip n-grams for the canonical names associated with the account are matched to the skip n-grams for the company/organization names associated with the social network profiles and profile-related information using a similarity match algorithm. In an example embodiment, the similarity match algorithm may be a cosine similarity match algorithm. At operation 808, it is determined if the results of the similarity match algorithm provide any matches. This may include, for example, comparing scores of individual candidate comparisons to a threshold. If there are matches, then the process may end.

If not, then at operation 810, addresses associated with the account are parsed into character skip n-grams. At operation 812, addresses associated with social network profiles and profile-related information are parsed into character skip n-grams. Once again, it should be noted that while in this diagram operation 812 is depicted as being performed after the addresses associated with a particular account are parsed, in some embodiments the addresses associated with social network profiles and profile-related information may be parsed beforehand, perhaps in a batch process occurring periodically regardless of when or if matching may need to occur. At operation 814, the skip n-grams for the addresses associated with the account are matched to the skip n-grams for the addresses associated with the social network profiles and profile-related information using a similarity match algorithm. In an example embodiment, the similarity match algorithm may be a cosine similarity match algorithm. At operation 816, it is determined if the results of the similarity match algorithm provide any matches. This may include, for example, comparing scores of individual candidate comparisons to a threshold. If there are matches, then the process may end.

If not, then at operation 818, email addresses associated with the account are parsed into character skip n-grams. At operation 820, email addresses associated with social network profiles and profile-related information are parsed into character skip n-grams. Once again, it should be noted that while in this diagram operation 820 is depicted as being performed after the email addresses associated with a particular account are parsed, in some embodiments the email addresses associated with social network profiles and profile-related information may be parsed beforehand, perhaps in a batch process occurring periodically regardless of when or if matching may need to occur. At operation 822, the skip n-grams for the email addresses associated with the account are matched to the skip n-grams for the email addresses associated with the social network profiles and profile-related information using a similarity match algorithm. In an example embodiment, the similarity match algorithm may be a cosine similarity match algorithm. At operation 824, it is determined if the results of the similarity match algorithm provide any matches. This may include, for example, comparing scores of individual candidate comparisons to a threshold. If there are matches, then the process may end.

If not, then at operation 826, webpages associated with the account are parsed into character skip n-grams. At operation 828, webpages associated with social network profiles and profile-related information are parsed into character skip n-grams. Once again, it should be noted that while in this diagram operation 828 is depicted as being performed after the webpages associated with a particular account are parsed, in some embodiments the webpages associated with social network profiles and profile-related information may be parsed beforehand, perhaps in a batch process occurring periodically regardless of when or if matching may need to occur. At operation 830, the skip n-grams for the webpages associated with the account are matched to the skip n-grams for the webpages associated with the social network profiles and profile-related information using a similarity match algorithm. In an example embodiment, the similarity match algorithm may be a cosine similarity match algorithm.

It should be noted that FIG. 8 depicts an example embodiment where subsequent fields are only examined if the examination of a prior field fails to find a match. For example, addresses are only examined if canonical names fail to find a match. In other example embodiments, all of the fields may be examined regardless of the results of the examination of the other fields. For example, in some embodiments the addresses may be examined to look for matches regardless of whether the canonical names yielded a match.

### CRM Contact to Social Network Profile Mapping

This section of the disclosure will describe the CRM contact to social network profile mapping. In an example embodiment, within the social network service, each profile may have at least one email address associated with it. As such, a mapping of email addresses to member identifiers can be established. In an example embodiment, the system may utilize this mapping of email addresses to member identifiers to map data from the CRM system to appropriate social network site profiles. In an example embodiment, the system may identify email addresses in the CRM data and use the mapping of email addresses to member identifiers to map that CRM data to the appropriate member identifier. If that is unsuccessful (for example if no email address is found in the CRM data or if an email address in the CRM data has no corresponding match in the mapping), then the system may look to names (e.g., first name and last name) in the CRM data. Character-based bi-grams may be formed (where space is not a character) from the names in the CRM data to match with names in the social network profiles. If this is unsuccessful, then the system may look to titles in the CRM data. Word based n-grams can be formed from the titles in the CRM data to match the titles in the social network profiles.

In an example embodiment, for each of these fields, a similarity match may be performed. In an example embodiment this may be a cosine similarity match. A set of the highest rated matches could then be returned. The set size is customizable and may be between 1 and any other positive integer.

In an example embodiment, a minimum number of matches is set such that if the set returned via the cosine similarity using one field has a size less than the minimum, additional matches may be retrieved by performing a matching algorithm on another field.

In an example embodiment, the matching for each of these fields may be performed in parallel.

In an example embodiment, a feature score is generated for one or more of the above features for each of a number of different user profiles. This may be performed by calculating the feature score:

$${f}_{s} = \frac{{S}_{1} ⋂ {S}_{2}}{{S}_{1} ⋃ {S}_{2}}$$

where fₛ is the feature score for the particular feature, S₁ is the set of all n-grams of the data corresponding to the feature in the CRM data, and S₂ is the set of all n-grams of the data corresponding to the feature in the social network profile.

Thus, if name (first name and last name) is considered a feature, then the feature score for first name and last name flₛ is equal to the intersection of all n-grams (in the case of first name and last name, character bi-grams) of names in the CRM data and the set of all n-grams of names in the social network profile, divided by the union of those two sets. Likewise, if title is considered a feature, then the feature score for title tₛ is equal to the intersection of all n-grams of titles in the CRM data and the set of all n-grams of titles in the social network profile, divided by the union of those two sets. Similar calculations can be used for a feature based on company fₑ.

In the case where multiple feature scores are used, the feature scores can be weighted to derive an overall importance of the feature score. For example, flₛ may be weighted by a name feature weight w_{fl}. Likewise, tₛ may be weighted by a title feature weight wₜ. Additionally, company feature score cₛ may be weighted by a company feature weight w_{c}.

In an example embodiment, rather than examine all features in parallel, a first pass algorithm is used where only a single feature is examined in a first pass and then the remaining features are examined in a second pass. This helps speed the matching process in systems having large numbers of social network profiles. For example, in a first pass, only names may be examined, finding profiles having “matching” names (matching being defined as having a feature score above a certain threshold, in that it is not necessary that the exact name be matched). Then only those matching profiles are used to create the sets for the second pass examination of the remaining features.

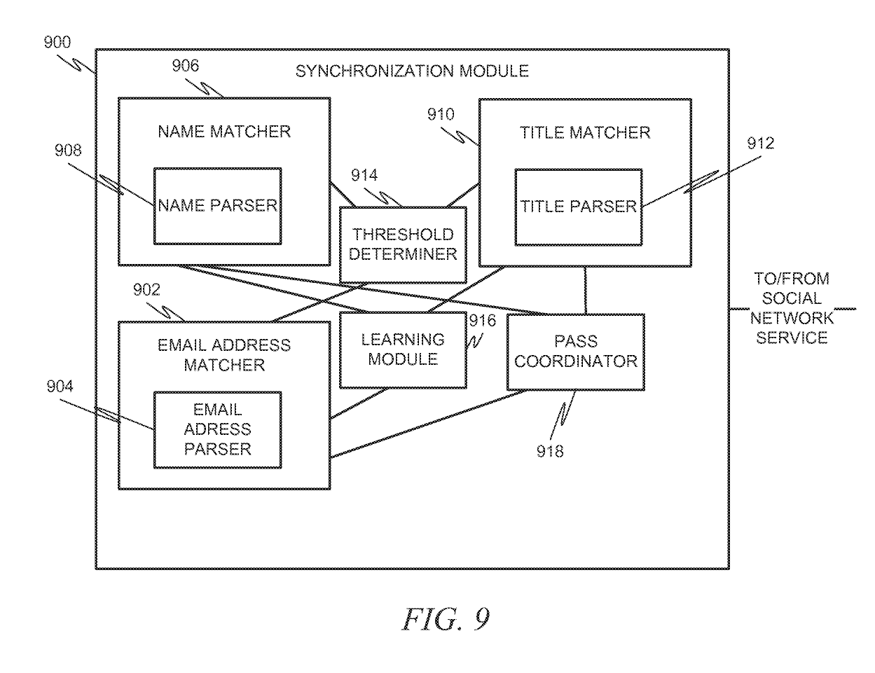

FIG. 9 is a block diagram illustrating a synchronization module 900, such as the synchronization module 128 of FIG. 1, in accordance with an example embodiment. The synchronization module 900 depicted here shows elements used to execute tasks related to mapping contacts stored in the tool data store 208. In one embodiment, the elements in FIG. 9 are combined with the elements in FIG. 2 or FIG. 6 (or both) into one synchronization module. However, embodiments are possible where the implementation of FIG. 9 utilizes data stored in the tool data store 208 that was acquired using different elements than those depicted in FIG. 2, or where no account matching is performed as in FIG. 6, and thus they are depicted in separate diagrams.

As in FIG. 6, the synchronization module 900 is shown as interfacing with a social network service to retrieve profiles and profile-related information. These profiles and profile-related information are used to map accounts from the CRM systems to companies/organizations in the social network service. Notably, in some example embodiments the synchronization module 900 may not directly interface with the social network service. Rather, another module may retrieve the needed information and store it in a memory, perhaps in the tool data store 208.

An email address matcher 902 may act to attempt to match email address information from contacts (stored as contact, account, or opportunity records in the tool data store 208) with email addresses from profiles. The email address matcher 902 may include an email address parser 904 used to parse email addresses into n-grams. Specifically, in one example embodiment the email address parser 904 parses both email addresses from the CRM contacts from the CRM system and the email addresses from the profiles into n-grams.

A name matcher 906 may act to attempt to match name information (e.g., first name, last name) from contacts with name information from profiles. The name matcher 906 may include a name parser 908 used to parse the names into n-grams. Specifically, in one example embodiment, the name parser 908 parses both names from the CRM contacts from the CRM system and names from the profiles into character-based bi-grams.

A title matcher 910 may act to attempt to match title information from contacts with title information from profiles. The title matcher 910 may include a title parser 912 used to parse the titles into n-grams. Specifically, in one example embodiment, the title parser 912 parses both titles from the CRM contacts from the CRM system and titles from the profiles into n-grams.

A threshold determiner 914 may act to determine if a potential match meets or exceeds a threshold matching value. As described above, a cosine similarity match may be performed for each field, and thus the threshold determiner 914 may determine whether the calculated cosine similarity value meets or exceeds a predefine threshold. If so, then a match has been found. It should be noted that the threshold determiner 914 can be utilized on a field-by-field basis or on all fields as a whole. For example, there may be a first threshold for matches by email address, a second threshold for matches by name, and a third threshold for matches by title. Alternatively, there may be one threshold for a weighted average of cosine matching values of the fields.

A learning module 916 may act to improve a low strength signal based on a threshold number of profiles in the social network data store identifying the value for the low-strength signal. Thus, the learning module 916 can interact with the email address matcher 902, name matcher 906, and title matcher 910 to alter the effect of the similarity match of each. Alternatively, the learning module 916 can dynamically alter the weight assigned to each field by the threshold determiner 914.

A pass coordinator 918 may act to implement a first pass ranking algorithm that may be used to speed up the matching process. This first pass ranking algorithm can operate the various similarity match algorithms for each of the fields in any order, which can act to reduce the processing cycles needed to locate matches.

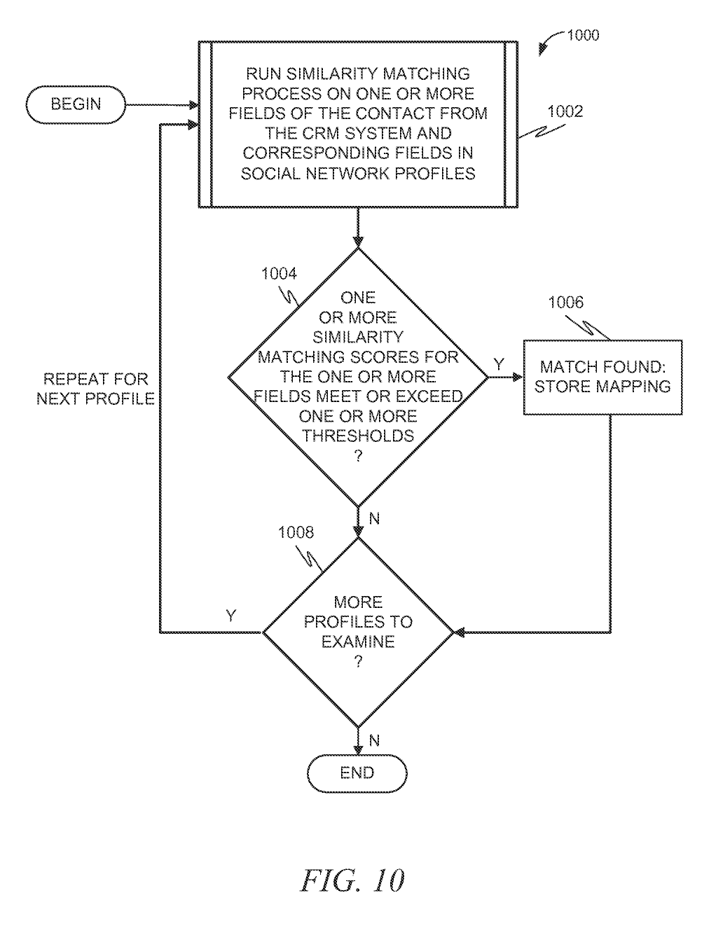

FIG. 10 is a flow diagram illustrating a method 1000 for mapping a contact from a CRM system to a profile in a social networking service, in accordance with an example embodiment. At operation 1002, a similarity matching process is run on one or more fields of the contact from the CRM system and corresponding fields in social network profiles. At operation 1004, one or more similarity matching scores for the one or more fields are compared with one or more thresholds. If the similarity matching scores meet or exceed the thresholds, then at operation 1006 a match has been found and a mapping between the CRM contact and the corresponding social network profile is stored. If not, then no match is found and at operation 1008 it is determined if there are any more profiles to examine. If so, then the process loops to operation 1002 for the next profile. This looping also occurs if there was a match. Once all the profiles have been examined, then the process ends.

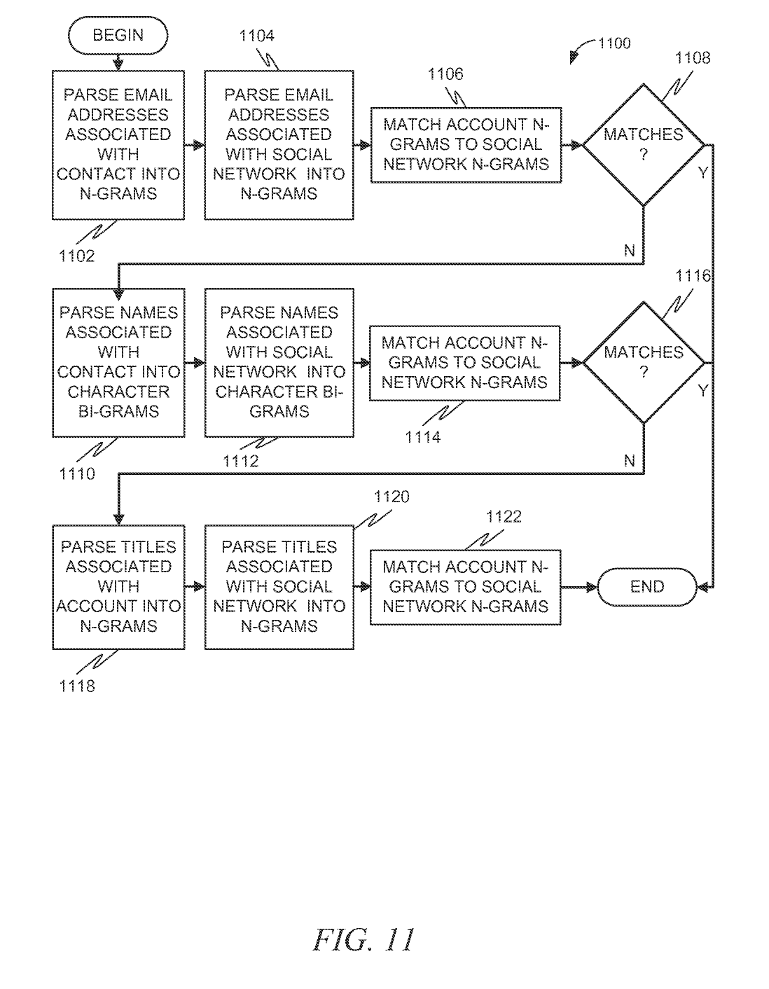

FIG. 11 is a flow diagram illustrating a method 1100 for performing a similarity matching process on one or more fields of a contact from a CRM system and corresponding fields in social network profiles, in accordance with an example embodiment. In one example embodiment, this method 1100 may represent operation 1002 of FIG. 10 in more detail.

At operation 1102, email addresses associated with the contact are parsed into n-grams. At operation 1104, email addresses associated with social network profiles are parsed into n-grams. It should be noted that while in this diagram operation 1104 is depicted as being performed after the email addresses associated with a particular contact are parsed, in some embodiments the email addresses associated with social network profiles may be parsed beforehand, perhaps in a batch process occurring periodically regardless of when or if matching may need to occur. At operation 1106 the n-grams for the email addresses associated with the contact are matched to the n-grams for the email addresses associated with the social network profiles using a similarity match algorithm. In an example embodiment, the similarity match algorithm may be a cosine similarity match algorithm. At operation 1108, it is determined if the results of the similarity match algorithm provide any matches. This may include, for example, comparing scores of individual candidate comparisons to a threshold. If there are matches, then the process may end.

If not, then at operation 1110, names associated with the contact are parsed into character bi-grams. At operation 1112, names associated with social network profiles are parsed into character bi-grams. It should be noted that while in this diagram operation 1112 is depicted as being performed after the names associated with a particular contact are parsed, in some embodiments the names associated with social network profiles may be parsed beforehand, perhaps in a batch process occurring periodically regardless of when or if matching may need to occur. At operation 1114 the character bi-grams for the names associated with the contact are matched to the character bi-grams for the names associated with the social network profiles using a similarity match algorithm. In an example embodiment, the similarity match algorithm may be a cosine similarity match algorithm. At operation 1116, it is determined if the results of the similarity match algorithm provide any matches. This may include, for example, comparing scores of individual candidate comparisons to a threshold. If there are matches, then the process may end.

If not, then at operation 1118, titles associated with the contact are parsed into n-grams. At operation 1120, titles associated with social network profiles are parsed into n-grams. It should be noted that while in this diagram operation 1120 is depicted as being performed after the titles associated with a particular contact are parsed, in some embodiments the titles associated with social network profiles may be parsed beforehand, perhaps in a batch process occurring periodically regardless of when or if matching may need to occur. At operation 1122 the n-grams for the titles associated with the contact are matched to the n-grams for the titles associated with the social network profiles using a similarity match algorithm. In an example embodiment, the similarity match algorithm may be a cosine similarity match algorithm.

### Example Mobile Device

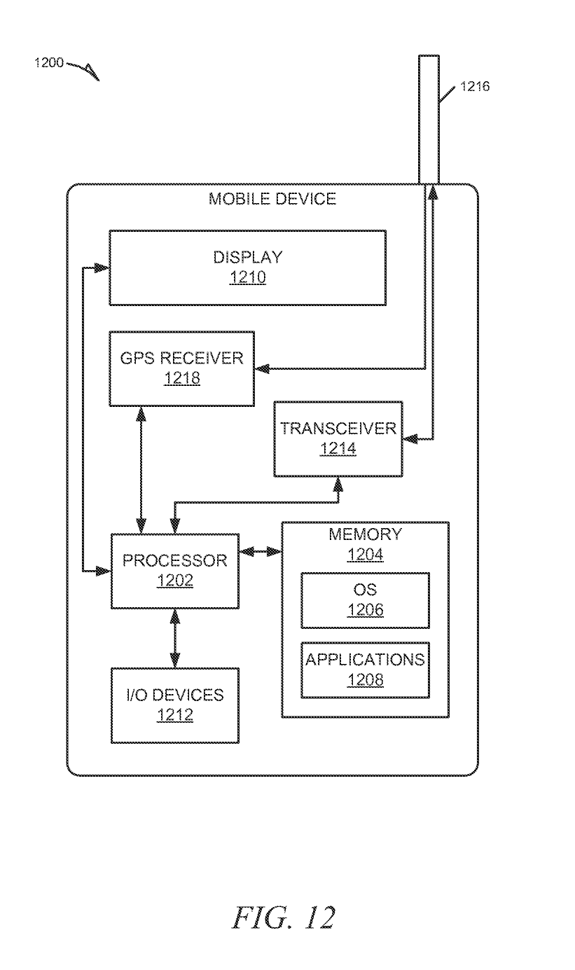

FIG. 12 is a block diagram illustrating a mobile device 1200, according to an example embodiment. The mobile device 1200 can include a processor 1202. The processor 1202 can be any of a variety of different types of commercially available processors 1202 suitable for mobile devices 1200 (for example, an XScale architecture microprocessor, a microprocessor without interlocked pipeline stages (MIPS) architecture processor, or another type of processor 1202). A memory 1204, such as a random access memory (RAM), a flash memory, or other type of memory, is typically accessible to the processor 1202. The memory 1204 can be adapted to store an operating system (OS) 1206, as well as application programs 1208. The processor 1202 can be coupled, either directly or via appropriate intermediary hardware, to a display 1210 and to one or more input/output (I/O) devices 1212, such as a keypad, a touch panel sensor, a microphone, and the like. Similarly, in some embodiments, the processor 1202 can be coupled to a transceiver 1214 that interfaces with an antenna 1216. The transceiver 1214 can be configured to both transmit and receive cellular network signals, wireless data signals, or other types of signals via the antenna 1216, depending on the nature of the mobile device 1200. Further, in some configurations, a GPS receiver 1218 can also make use of the antenna 1216 to receive GPS signals.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors 1202 can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor 1202 or other programmable processor 1202) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 1202 configured using software, the general-purpose processor 1202 can be configured as respective different hardware-implemented modules at different times. Software can accordingly configure a processor 1202, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple of such hardware-implemented modules exist contemporaneously, communications can be achieved through signal transmission (e.g., over appropriate circuits and buses that connect the hardware-implemented modules). In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation, and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors 1202 that are temporarily configured (e.g., by software) or permanently configured to perform the relevant operations. Whether temporarily or permanently configured, such processors 1202 can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors 1202 or processor-implemented modules. The performance of certain of the operations can be distributed among the one or more processors 1202, not only residing within a single machine, but deployed across a number of machines. In some example embodiments, the processor 1202 or processors 1202 can be located in a single location (e.g., within a home environment, an office environment or as a server farm), while in other embodiments the processors 1202 can be distributed across a number of locations.

The one or more processors 1202 can also operate to support performance of the relevant operations in a “cloud computing” environment or as a “software as a service” (SaaS). For example, at least some of the operations can be performed by a group of computers (as examples of machines including processors 1202), these operations being accessible via a network (e.g., the Internet) and via one or more appropriate interfaces (e.g., application program interfaces (APIs).)

### Electronic Apparatus and System

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor 1202, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors 1202 executing a computer program to perform functions by operating on input data and generating output. Method operations can also be performed by, and apparatus of example embodiments can be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 1202), or a combination of permanently and temporarily configured hardware can be a design choice. Below are set out hardware (e.g., machine) and software architectures that can be deployed, in various example embodiments.

### Example Machine Architecture and Machine-Readable Medium

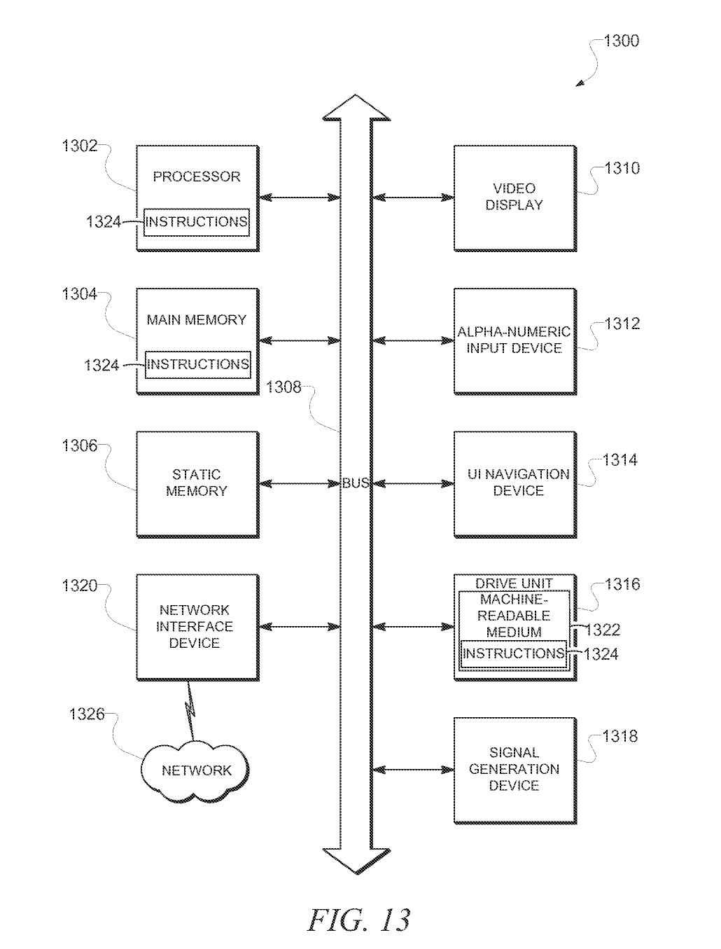

FIG. 13 is a block diagram of a machine in the example form of a computer system 1300 within which instructions 1324 can be executed, for causing the machine to perform any one or more of the methodologies discussed herein. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a CPU, a graphics processing unit (GPU), or both), a main memory 1304 and a static memory 1306, which communicate with each other via a bus 1308. The computer system 1300 can further include a video display unit 1310 (e.g., a liquid crystal display (LCD) or a cathode ray tube (CRT)). The computer system 1300 also includes an alphanumeric input device 1312 (e.g., a keyboard or a touch-sensitive display screen), a user interface (UI) navigation device 1314 (e.g., a mouse), a disk drive unit 1316, a signal generation device 1318 (e.g., a speaker), and a network interface device 1320.

### Machine-Readable Medium

The disk drive unit 1316 includes a machine-readable medium 1322 on which is stored one or more sets of instructions and data structures (e.g., software) 1324 embodying or utilized by any one or more of the methodologies or functions described herein. The instructions 1324 can also reside, completely or at least partially, within the main memory 1304 and/or within the processor 1302 during execution thereof by the computer system 1300, the main memory 1304 and the processor 1302 also constituting machine-readable media 1322.

While the machine-readable medium 1322 is shown in an example embodiment to be a single medium, the term “machine-readable medium” can include a single medium or multiple media (e.g., a centralized or distributed database, and/or associated caches and servers) that store the one or more instructions 1324 or data structures. The term “machine-readable medium” shall also be taken to include any tangible medium that is capable of storing, encoding or carrying instructions 1324 for execution by the machine and that cause the machine to perform any one or more of the methodologies of the present disclosure or that is capable of storing, encoding or carrying data structures utilized by or associated with such instructions 1324. The term “machine-readable medium” shall accordingly be taken to include, but not be limited to, solid-state memories, and optical and magnetic media. Specific examples of machine-readable media 1322 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1324 can further be transmitted or received over a communications network 1326 using a transmission medium. The instructions 1324 can be transmitted using the network interface device 1320 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 1324 for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method comprising:
receiving a request to onboard a first user to a software tool;
performing a first query on information in a Customer Relationship Management (CRM) system to obtain a first set of CRM accounts, wherein each CRM account is a record corresponding to an organization, and the first query is performed for accounts in the CRM system having an owner identification field matching an owner identification of the first user, wherein a user identification being contained in an owner identification field of a particular CRM account Indicates that the user corresponding to the user identification has been previously assigned to the organization corresponding to the particular CRM account;
performing, a second query on information in the CRM system to obtain a second set of CRM accounts, the first and second queries designed to retrieve CRM accounts related to the first user, the second query being performed to obtain CRM accounts having at least one team member field matching the first user; and
storing results of the first and second queries in a database controlled by the software tool as a single data type, wherein the software tool is separate and distinct from the CRM system and is configured to provide insights into the results based at least in part on information from social network profiles related to the results.

2. (canceled)

3. The method of claim 1, further comprising:
identifying a first set of contacts listed in accounts retrieved during the first and second queries and storing the first set of contacts in the software tool;
performing a third query on contacts listed in contact records related to the first user in the CRM system;
storing the contacts listed in the contact records returned by the third query as a second set of contacts in the software tool;
performing a fourth query on contacts listed in opportunity records related to the first user in the CRM system; and
storing the contacts listed in the opportunity records returned by the fourth query as a third set of contacts in the software tool.

4. The method of claim 1, wherein the first query and the second query are customized for a type of the CRM system.

5. The method of claim 1, wherein the first query and the second query are customized for the first user.

6. The method of claim 1, wherein the first query and the second query are customized for all users working for a particular company.

7. The method of claim 1, further comprising:
performing a first query on information in a second CRM system to obtain a first set of CRM entities of a second type;
performing, a second query on information in the second CRM system to obtain a second set of CRM entities of the second type, the first and second queries designed to retrieve CRM entities related to the first user; and
storing results of the first and second queries on information in the second CRM system in the software tool as a single data type, wherein the software tool is separate and distinct from the second CRM system and is configured to provide insights into the results based at least in part on information from social network profiles related to the results.

8. A computer-implemented system comprising:
a data store;
a synchronization module configured to:
receive a request to onboard a first user;
perform a first query on information in a CRM system to obtain a first set of CRM accounts, wherein each CRM account is a record corresponding to an organization, the first query is performed for accounts in the CRM system having an owner identification field matching an owner identification of the first user, wherein a user identification being contained in an owner identification field of a particular CRM account Indicates that the user corresponding to the user identification has been previously assigned to the organization corresponding to the particular CRM account;
perform, a second query on information in the CRM system to obtain a second set of CRM accounts, the first and second queries designed to retrieve CRM accounts related to the first user, the second query is performed to obtains CRM accounts having at least one team member field matching the first user, and
store results of the first and second queries in the data store as a single data type; and
an insight module configured to:
provide insights into the results based at least in part on information from social network profiles related to the results.

9. The system of claim 8, wherein the providing insights includes mining Internet data to provide information about accounts or leads that have value to the first user.

10. The system of claim 8, further comprising a recommendation module configured to recommend further accounts and/or leads based on the stored results of the first and second queries.

11. The system of claim 8, wherein the social network profiles are accessed in a social network service.

12. The system of claim 8, wherein the synchronization module includes a first CRM interface configured to retrieve first CRM rules from a rules store and execute the first CRM rules to perform the first and second queries.

13. The system of claim 12, wherein the synchronization module further includes a second CRM interface configured to retrieve second CRM rules from the rules store and execute the second CRM rules to perform first and second queries on a second CRM system.

14. The system of claim 12, wherein the first CRM interface is further configured to retrieve customized CRM rules for the first user from the rules store and execute customized CRM rules to perform queries.

15. A non-transitory machine-readable storage medium having instruction data to cause a machine to perform the following operations:
receiving a request to onboard a first user to a software tool;
performing a first query on information in a Customer Relationship Management (CRM) system to obtain a first set of CRM accounts, wherein each CRM account is a record corresponding to an organization, and the first query is performed for accounts in the CRM system having an owner identification field matching an owner identification of the first user, wherein a user identification being contained in an owner identification field of a particular CRM account indicates that the user corresponding to the user identification has been previously assigned to the organization corresponding to the particular CRM account;
performing, a second query on information in the CRM system to obtain a second set of CRM accounts, the first and second queries designed to retrieve CRM accounts related to the first user, the second query being performed to obtain CRM accounts having at least one team member field matching the first user; and
storing results of the first and second queries in a database controlled by the software tool as a single data type, wherein the software tool is separate and distinct from the CRM system and is configured to provide insights into the results based at least in part on information from social network profiles related to the results.

16. The non-transitory machine-readable storage medium of claim 15, wherein the CRM entities of the first type are accounts, the first query is performed for accounts in the CRM system having an owner identification matching an owner identification of the first user and the second query is performed for accounts in the CRM system listing at least one team member matching the first user.

17. The non-transitory machine-readable storage medium of claim 16, further comprising:
identifying a first set of contacts listed in accounts retrieved during the first and second queries and storing the first set of contacts in the software tool;
performing a third query on contacts listed in contact records related to the first user in the CRM system;
storing the contacts listed in the contact records returned by the third query as a second set of contacts in the software tool;
performing a fourth query on contacts listed in opportunity records related to the first user in the CRM system; and
storing the contacts listed in the opportunity records returned by the fourth query as a third set of contacts in the software tool.

18. The non-transitory machine-readable storage medium of claim 15, wherein the first query and the second query are customized for a type of the CRM system.

19. The non-transitory machine-readable storage medium of claim 15, wherein the first query and the second query are customized for the first user.

20. The non-transitory machine-readable storage medium of claim 15, wherein the first query and the second query are customized for all users working for a particular company.
